(19) United States
(12) Patent Application Publication
(10) Pub. No.: US 2013/0262204 A1
(43) Pub. Date: Oct. 3, 2013

(54) PROMOTION TARGETING, FULFILLING, TRACKING, AND MANAGING

(71) Applicant: EXTOLE, INC., San Francisco, CA (US)

(72) Inventors: Adam Stiles, Pasadena, CA (US); Jonathan Woolf, San Francisco, CA (US); Blake Hayward, San Francisco, CA (US)

(73) Assignee: EXTOLE, INC., San Francisco, CA (US)

(21) Appl. No.: 13/855,511

(22) Filed: Apr. 2, 2013

Related U.S. Application Data
(60) Provisional application No. 61/619,303, filed on Apr. 2, 2012.

(51) Int. Cl. G06Q 30/02

(52) U.S. Cl. CPC G06Q 30/0211
USPC 705/14.13

(57) ABSTRACT

An integrated, online approach to handling aspects of customer promotions can include a promotional management module for use by a client vendor. The promotional management module can integrate with the client vendor's existing online commerce portal and/or with a social networking service or the like to provide a user with an enhanced shopping experience by presenting one or more offers that the user can redeem via e-commerce (e.g. online selection and payment), in-person (e.g. at a physical location of the client vendor, or via other approaches.

### CROSS-REFERENCE TO RELATED APPLICATIONS

The current application is claims priority under 35 U.S.C. §119(e) to U.S. Provisional Application No. 61/619,303, filed Apr. 2, 2012 and entitled “Promotion Targeting, Fulfilling, Tracking, and Managing,” the disclosure of which is incorporated herein by reference.

### TECHNICAL FIELD

The subject matter described herein relates to generally to customer promotions, and specific.

### BACKGROUND

Coupons, promotional offers, and other methods of discounting the price of goods or services as a trade-off of reduced profit margins per unit of sale in exchange for a (hopefully) increased volume of such units of sale have long been a key element in marketing and sales growth strategies. Various approaches have come into common use with the advent of widespread commercial transactions over the Internet (typically referred to as e-commerce, Web commerce, online shopping, or the like). Some of these approaches are managed directly by the vendor. For example, in both physical retail locations (e.g. stores where goods or services are sold or provided, shopping centers, outlet malls, or the like) and online retail portals (e.g. web merchants or other e-commerce sites including online portals operated by physical stores), retailers have historically offered sales on all or selected merchandise or services, electronic and/or physical (e.g. paper) coupons, customer loyalty programs, etc. as part of efforts to increase sales volumes and acquire new customers. A retailer or other vendor of goods or services might, for example, offer a coupon or other promotional offer that enables a consumer to receive a discount of a fixed amount or percentage of the cost of a complete or partial order or even a single item of goods or services. Such fixed amount or percentage discounts have been used both in physical and online stores.

More recently, “daily deal” services provided by online promotion service providers such as Groupon (provided by Groupon, Inc. of Chicago, Ill.), LivingSocial.com (provided by LivingSocial LTD of London, UK), Google Offers (provided by Google, Inc. of Mountain View, Calif.), Amazon Local (provided by Amazon.com of Seattle, Wash.), and the like have built a promotional service business model on the concept of purchasing (or contracting to purchase) a large number of sales units from a client vendor (hereinafter referred to as a “client vendor” or a “promotional services client” at a steeply discounted price and then reselling those sales units to consumers (e.g. shoppers, customers, etc.) in a prepaid arrangement that can include a time limit during which the purchased goods or services must be redeemed. It should be noted that while this approach is referred to herein as a “daily deal,” one of ordinary skill in the art would readily understand that the time period for a consumer to purchase a promotion of this nature need not be exactly one day.

However, each of the above-described approaches to driving customer traffic to both physical retail locations and online retail portals via price-discounting promotions generally suffers from several drawbacks that negatively impact one or more of the customer experience and the value realized by the client vendor. For example, with a traditional discount offer or coupon, the client vendor generally has little or no control over how often the offer is used and also typically receives little or no information regarding the consumer or consumers who take advantage of the offer. Additionally, the client vendor has limited ability to track instances of a consumer receiving such a discount offer and then failing to complete a purchase transaction or to identify possible reasons for lack of completion and/or potential approaches to improve capture of a sale after a consumer has received a promotional offer.

With “daily deals” promotions, the client vendor is required to pre-sell a large number of sale units to the online promotion service provider, who then resells these sales units to consumers with an added margin. While this approach can drive significant traffic to the client vendor, in general, little loyalty is generated between the consumer using the deal and the client vendor. Rather, consumer users of daily deal promotions are more likely to have loyalty to the online promotion service provider than to the client vendor, so the “loss leader” approach of taking a very small profit margin or even a loss on a high volume of sales units can commonly fail to drive added consumer traffic at price points that are sustainable for the client vendor. Additionally, the client vendor receives very little information about the consumers who redeem the purchased daily deal promotions and thus receives very little useful feedback that can be used for improved marketing of the client vendors goods and/or services.

### SUMMARY

Implementations of the current subject matter can, among other possible advantages, provide an integrated, online approach to handling all or at least one or more aspects of customer promotions. A client vendor can employ a promotional management module, for example one provided by a promotional services provider, that integrates with the client vendor's existing online commerce portal and/or with a social networking service or the like to provide a user with an enhanced shopping experience by presenting one or more offers that the user can redeem via e-commerce (e.g. online selection and payment), in-person (e.g. at a physical location of the client vendor, or via other approaches.

In one aspect, a method includes receiving, at a backend server from a consumer device, a selection by a consumer user of a user interface feature in a web page displayed by the consumer device. The web page includes a user interface representation of an offer or promotion served from the backend server, and the selection indicates intent by the consumer user to perform an action relating to the offer or promotion represented by the promotional offer representation. The method further includes verifying authentication of the consumer user, and serving, from the backend server to the consumer device, an offer page for display to the consumer user. The offer page includes one or more delivery options allowing redemption of the offer or promotion by the consumer user. The method further includes tracking redemption of the offer or promotion by the consumer user, and providing, to a vendor who offers the offer or promotion, one or more offer or promotion creation, management, and tracking capabilities via a promotional management module that communicates with the backend server.

In some variations one or more of the following features can optionally be included in any feasible combination. The one or more creation, management, and tracking capabilities can include at least one of defining the promotion or offer based upon consumer user types, using a rule engine to target consumer users based upon specified criteria, defining and/or selecting options relating to non-redemption of claimed offers or promotions, influencing claiming and/or redemption of offers or promotions. A method can include providing a promotional management module that runs within the web page displayed by the consumer device. The promotional management module can communicate with the backend server to send the selection for receiving by the backend server and to receive the server offer page.

Verifying authentication of the consumer user can include determining whether the consumer user has already been authenticated and either serving the offer page for display to the consumer user via the consumer device when the consumer user has already been authenticated at the time of the receiving of the selection; or when the consumer user has not already been authenticated at the time of the receiving of the selection, communicating to the consumer device to request that the consumer user accept authentication of the consumer user's identity and allow access to the consumer user's profile data stored at an authentication data repository accessible by an authentication server, and upon receiving acceptance from the consumer user via the consumer device, serving the offer page for display to the consumer user via the consumer device. The authentication server can include a third party authentication server. The determining can include performing a cache check, which can include accessing an authorization cache at the backend server to determine whether a stored authorization exists for the consumer user. A method can further include providing an authentication module that runs within the web page displayed by the consumer device. The authentication module can communicate with the authentication server as part of the verifying authentication of the consumer user, and can perform operations that include at least one of returning crypto-signed authorization data when the consumer user has already been authenticated and executing an authorization process, when the consumer user has not already been authenticated.

Implementations of the current subject matter can include, but are not limited to, systems and methods including one or more features as described herein and illustrated in the accompanying drawings as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a promotional management module provided for use by a client vendor by a third-party promotional services provider software solution or architecture, it should be readily understood that such features are not intended to be limiting. For example, the client vendor can alternatively provide one or more backend services supporting a promotional management module directly rather obtaining such services from the third-party promotional services provider (e.g. via a software-as-a-service arrangement). Likewise, while the illustrative examples herein make reference to third party authentication servers or services and specifically to leveraging of the capabilities of third party services such as social networks for authentication of a consumer, tracking of consumer claiming and redemption of promotional offers, and publication of these activities to other users, these examples are not intended to be limiting. Other approaches to authenticating the identity and to obtaining one or more pieces of information relating to consumers who claim and/or redeem or fail to redeem claimed offers are also within the scope of this disclosure. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a computing system architecture showing features consistent with implementations of the current subject matter;

FIG. 2 shows a process flow diagram illustrating aspects of data flows having one or more features consistent with implementations of the current subject matter;

FIG. 3 shows a process flow diagram illustrating aspects of data flows having one or more features consistent with implementations of the current subject matter;

FIG. 4 shows a process flow diagram illustrating features of a method consistent with implementations of the current subject matter;

FIG. 5 is a screen shot showing an example of a promotion management module displayed on a web page generated by a client vendor's e-commerce module;

FIG. 6 is a screen shot showing an example of an authentication module (e.g. provided through a social network site such as Facebook or the like) displayed on a web page generated by a client vendor's e-commerce module; and

FIG. 7 is a screen shot showing an example of delivery of a deferred redemption option such as a print and shop coupon provided by a promotion management module and displayed on a web page generated by a client vendor's e-commerce module.

When practical, similar reference numbers denote similar structures, features, or elements.

### DETAILED DESCRIPTION

Using an integrated, online approach to handling all or at least one or more aspects of customer promotions, such as for example an approach including one or more features as described herein, a client vendor can employ a promotional management module that integrates with the client vendor's existing online commerce portal and/or with a social networking service or the like to provide a user with an enhanced shopping experience by presenting one or more offers that the user can redeem via e-commerce (e.g. online selection and payment), in-person (e.g. at a physical location of the client vendor, or via other approaches. A promotional services provider can optionally be provide the promotion management module. Rather than a promotional service provider soliciting new offers from a client vendor and then purchasing in bulk the right to sell those offers to consumers, consistent with implementations of the current subject matter, a promotional service provider can cooperate in a more integrated manner with a client vendor's existing promotions and e-commerce portal to provide enhanced control of promotional offers to the client vendor as well as the ability to more closely track the redemption or non-redemption of claimed promotional offers and to obtain additional data about the consumers who redeem or do not redeem the promotional offers that have been claimed.

In general, the current subject matter is described using several terms that are intended to have certain meanings. For example, a promotional offer representation of an offer or promotion can include one or more of graphical, textual, audio, video, or other media describing or otherwise providing information about the offer or promotion offered by a client vendor. A promotional offer representation can further include an embedded user interface input feature via which a user can claim the represented offer or promotion. A user interface input feature can include one or more of a link, a “button” or the like (e.g. using an input device such as a touch screen, mouse, keyboard, voice recognition functionality, etc.), a speech recognition input, a visual input (e.g. via a camera associated with a consumer device, a kinetic motion associate with the device (e.g. swiping of a touchpad or screen, causing motion detectable by a motion sensing feature of the consumer device, etc.). A promotional offer representation presented using one or more features of the current subject matter can be embedded within a client vendor's website, a client vendor's mobile device application (e.g. an “app” for iOS provided by Apple Computer, Inc. of Cupertino, Calif. or for the Android operating system provided by Google, Inc. or an application or the like for other mobile device operating systems), a client vendor's e-commerce portal, or the like. Alternatively, promotions can be delivered in association with a customer's use of a social media network (e.g. Facebook, Twitter, etc.), via direct e-mail, SMS and MMS messages, other types of mobile device notifications, or the like.

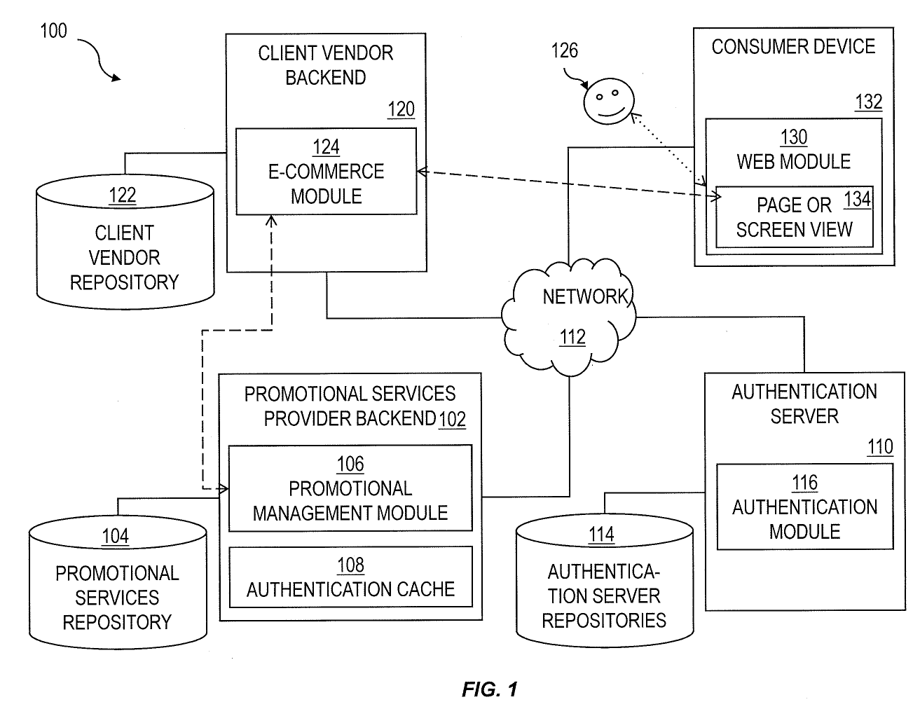

FIG. 1 shows a diagram illustrating features of a comuting architecture or framework 100, at least some of which can occur in one or more implementations of the current subject matter. In an illustrative example, a promotional services provider supplies a promotional service provider backend 102, which can include one or more physical or virtual servers that maintain or otherwise have access to one or more promotional services repositories 104 (e.g. databases that are retained on one or more types of computer readable storage media). The one or more promotional services repositories 104 can be accessed by the promotional service provider backend 102 via a direct connection (e.g. a local area network or a system bus or the like) or over a wide area network (e.g. via the Internet or other access to a cloud-based database server system. The promotional service provider backend 102 can serve one or more promotional management modules 106 (which can in some examples be JavaScript modules or the like) as web applications that provide functionality described in greater detail below. An authorization cache 108, whose functions are explained in greater detail below, can also be included as part of or otherwise accessible to the promotional service provider backend 102.

An authentication server 110 can exchange communications with the promotional service provider backend 102, for example by receiving and sending data via a network 112. The authentication server 110 can include one or more physical or virtual servers that maintain or otherwise have access to one or more authentication data repositories 114 (e.g. databases that are retained on one or more types of computer readable storage media). The one or more authentication server repositories 114 can be accessed by the authentication server backend 110 via a direct connection (e.g. a local area network or a system bus or the like) or over a wide area network (e.g. via the Internet or other access to a cloud-based database server system). The one or more authentication server repositories 114 can optionally store one or more of data pertaining to consumer or user authentication, user or consumer profile data, or the like. The authentication server 110 can serve one or more authentication modules 116 (which can in some examples be JavaScript modules or the like) as web applications that provide functionality described in greater detail below. While the authentication server 110 is shown in FIG. 1 as being separate from the promotional service provider backend 102 and in communication with the promotional service provider backend 102 via the network 112, it will be readily understood by one of ordinary skill in the art that the authentication server 110 and the promotional service provider backend 102 can be collocated or even hosted by the same one or more physical or virtual servers. In other words, a same processing machine or machines can execute the one or more authentication modules 116 and the one or more promotional management modules 106.

A client vendor can own, use, maintain, etc. a client vendor backend 120, which can include one or more physical or virtual servers that maintain or otherwise have access to one or more client vendor repositories 122 (e.g. databases that are retained on one or more types of computer readable storage media). The one or more client vendor repositories 122 can be accessed by the client vendor backend 120 via a direct connection (e.g. a local area network or a system bus or the like) or over a wide area network (e.g. via the Internet or other access to a cloud-based database server system. The client vendor backend 120 can execute one or more e-commerce modules 124 that provide functionality in support of an online e-commerce portal. This functionality can include, but is not limited to, the operation of a web store, product ratings and reviews, shopping cart functionality, product browsing, product search, payment handling, catalog management, catalog browsing, order management, customer account management, content management, analytics and reporting, mobile commerce, and the like. It will be readily understood by one of ordinary skill in the art that, while FIG. 1 shows only a single client vendor being supported by a promotional services provider, more than one client vendor and the associated client vendor backend 120 can be supported by a single promotional service provider backend 102. Either option is within the scope of the current subject matter.

One or more consumers 126 can access the functionality of the one or more e-commerce modules 124, for example by pointing a web module 130 executing on a consumer device 132 toward a network address (e.g. a URL, etc.) that invokes the one or more e-commerce modules 124 to cause the display to the consumer 126 of a web page 134, which is served from the one or more e-commerce modules 124 to provide an online shopping environment with which the consumer can interact via one or more user interface input features and/or input, output, and display devices associated with the consumer device 132. For the purposes of this description, references to a web module 130 and a web page 134 displayed within the web module 130 are intended to be inclusive of any type of client-server arrangement in which a local thin client, which can optionally be a web browser, displays information to a user via one or more web pages 134. In other implementations, the web module can include a shopping “app” or other application running in a mobile device operating system environment, etc. provided by a client vendor to deliver all or a subset of online shopping features optimized for use on a mobile computing device such as a smart phone or tablet, can run one or more web or network-served applets, applications, etc., that provide functionality supporting one or more of the features described herein. In this context, the web page 134 can be a screen view within such an app, application, applet, etc. The consumer device 132 can be a desktop or laptop computer, a smart-phone, a personal data assistant, a tablet computing device, or the like.

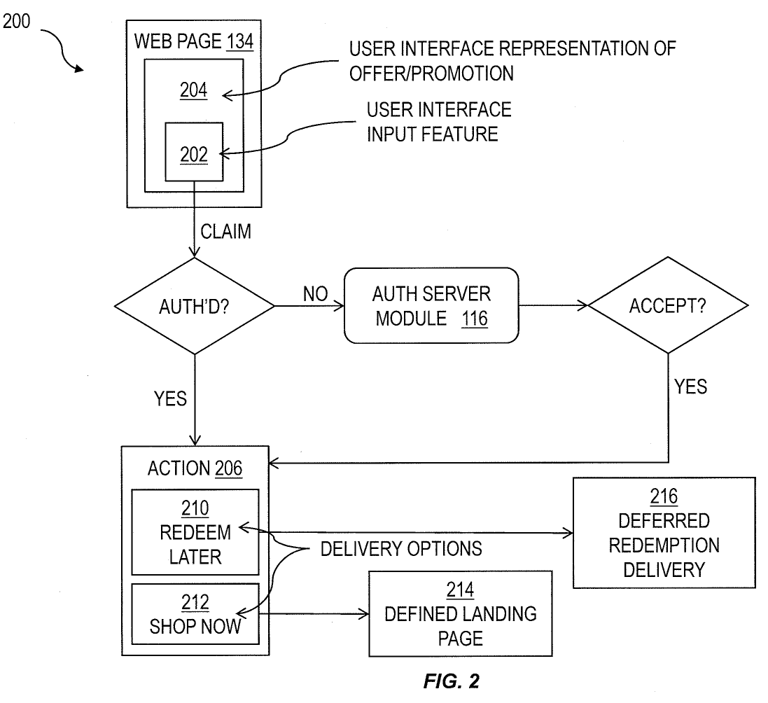

FIG. 2 shows a process flow chart 200 that illustrates features of a process via which a consumer can interact with a client vendor's e-commerce features enhanced by promotional management features provided by a promotional services provider. The consumer clicks on or otherwise selects a user interface input feature 202 in a web page 134 displayed within a web module 130 executed on a consumer device 132. The web page 134 can include embedded therein a user interface representation 204 of an offer or promotion that is served from the one or more promotional management modules 106 at the promotional service provider backend 102. The promotional offer representation 204 can include the user interface interaction feature 202. Selection of the user interface input feature 202 by the consumer 126 (not shown in FIG. 2) indicates intent by the consumer 126 to perform an action relating to the offer or promotion represented by the promotional offer representation 204 and causes communication of the action 206 to the one or more promotional management modules 106. An action 206 can include one or more of claiming, sharing, “liking,” wanting (e.g. placing on a “wish list”), etc. the offer or promotion.

The one or more promotional management modules 106 can perform a cache check to determine whether the consumer 126 has already been authorized. The cache check can access the authorization cache 108 at the promotional service provider backend 102 to determine whether the consumer has already been authenticated. If so, the one or more promotional management modules 106 can serve an offer page 206 to the web module 130 at the consumer device 132. The offer page 206 can optionally provide a first delivery option 210 for a delayed redemption capability that can allow redemption by the consumer 126 of the claimed offer or promotion at a later time and/or a second delivery option for a “shop now” option 212 that enables the consumer 126 to proceed to a defined landing page 214, for example to access a shopping cart or other shopping features provided by the one or more e-commerce modules 124 of the client vendor. Selection by the consumer 126 of the first delivery option 210 can invoke delivery of a deferred redemption option 216, which is discussed in more detail below.

If the authorization cache 108 lacks a stored authorization for the consumer 126 or if the current state of a stored authorization is not current or otherwise invalid or insufficient, the promotional service provider backend 102 can communicate with the authentication server 110 to invoke the one or more authentication modules 116, which can cause the web module 130 at the consumer device 132 to convey a request that the consumer 126 accept authentication of his or her identity and also that he or she allow access to his or her profile data, if any, stored in the one or more authentication data repositories 114. Assuming the consumer 126 accepts, the offer page 206 discussed above is displayed via the web module 130 at the consumer device 132.

In an further example of a third party authentication process, the one or more promotional management modules 106 and the one or more authentication modules 116 served from the promotional service provider backend 102 and the authentication server 110, respectively can run within the web page 134 displayed in the web module 130 at the consumer device 132. The authentication server 110 can be operated or otherwise controlled by a social network service provider or the like. The one or more promotional management modules 106 can invoke the one or more authentication modules 116 to request a user authentication, authorization, or the like. Operations performed by the one or more authentication modules 116 can include returning crypto-signed authorization data (described below), for example when a user authorization is already cached and a state of the authorization is known or, alternatively, executing an authorization process, for example if a user authorization is not already cached and/or if a state of the authorization is not known. The executing of the authorization process can optionally include one or more of generating a pop-up window, pull-down tab, authentication page or screen, or the like, to enable invocation of and communication with an authorization server associated the third party authentication service. After successful completion either of the confirming that the consumer is already authenticated or the invoking of and communicating with the authorization server 110 (e.g. one associated with a social networking site or other third party authentication service) to allow the consumer 126 to become authenticated, the authentication module 116 can initiate a call back to the one or more promotional management modules 106 to pass cryptographically signed authentication data (which can include one or more of a user id, a valid, verifiable digital signature, and an access token) that can be invoked by the promotional services provider to take action on behalf of the consumer 126.

The one or more promotional management modules 106 can perform one or more of several functions. For example, the one or more promotional management modules 106 can communicate directly with a third party authentication server to obtain user profile data from a user profile created by or maintained for the consumer 126 on a social network or other service with which the third party authentication server is associated. Obtaining of user profile data can also be referred to as “slurping.” The one or more promotional management modules 106 can also communicate directly with the authentication server 110 to create structured data in the form of actions and posts that appear on social networks, client websites, and the like (e.g. via an open graph functionality such as is provided by Facebook); send authorization data and/or an access token or the like to a server or other backend service associated with the promotional services provider (which can take one or more actions on behalf of the consumer from the server side); send authorization data and/or an access token or the like to a promotional services provider backend so that the promotional services provider backend 102 can return a coupon code or the like for the one or more promotional management modules 106 to inject into the web page 134 for display to the consumer 126; and the like.

A delivery option 210 of a claimed offer or promotion can include one or more of several options. For example, an authenticated consumer that claims an offer or promotion can be presented with a redemption type chosen from a coupon code or codes (which can include static codes or unique codes, a printable coupon, for example a coupon that can be printed for use in a physical store, or the like), a trackable link with a coupon code embedded therein, or the like. Unique coupon codes can be used to prevent fraud or gaming of an offer or promotion, for example by dynamically issuing only one code per user. Delivery of coupons or codes to consumers can in various options be limited based upon unique identifiers, such as for example a social network user identification of the consumer, an IP address used by a consumer, an e-mail address of the consumer, or the like. A trackable link can optionally include a promotional ID that the client vendor can use to track and automatically apply a promotion code to the consumer's online shopping cart. Another promotion delivery option can include copying of a coupon code to a clipboard or other similar functionality at the consumer device 132 so that the copied coupon code can be pasted into a redemption window or field as part of a checkout process or, alternatively, pasted by the consumer into a document for storage and later use. Coupon codes can also be sent to consumers through SMS/MMS, other mobile device communications or notifications, or the like for both online and in-store use.

Promotional thresholds can be used in some implementations, for example to limit the number of claimed offers (for example to a set number of claim offers before the offer or promotion is deactivated for additional claims), to limit a duration of an offer or promotion (for example to a set time period), which can optionally include notifying a consumer of the expiration through triggering an expiration page (for example by redirecting a web module to another page, by messaging in an embedded module, etc.), or the like.

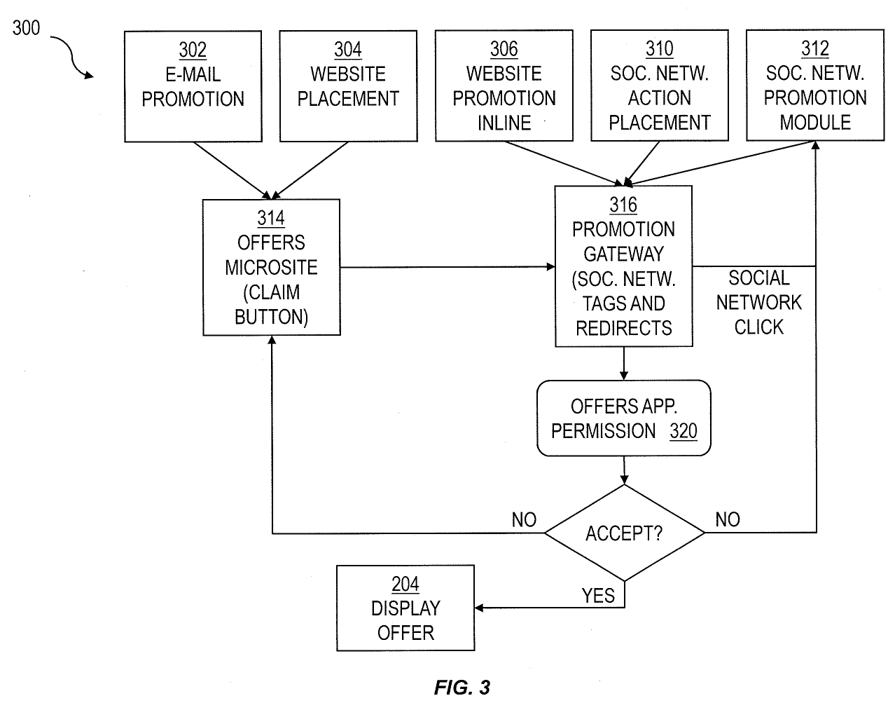

FIG. 3 shows a process flow chart 300 illustrating data flow features consistent with one or more implementations of the current subject matter. A promotion management module 106 can utilize one or more of several possible channels to reach potential consumers 126 and to thereby alert consumers 126 to the availability of an offer or promotion. These channels can optionally include, but are not limited to, e-mail promotions 302, website placement 304, website in-line promotions 306, social network action placement 310, social network promotion modules 312, and the like, and can also optionally include one or more of display ads, adwords, sponsored stories, and the like. E-mail promotions 302 and website placement 304 can include, for example, a clickable link or buttons or advertisement that can direct a web module 130 at a consumer device 132 to an offers microsite 314. This offers microsite 314 can include a more detailed description of the offer or promotion, of the client vendor offering the offer or promotion, of merchandise or services available from the client vendor, or the like. The offers microsite 314 can also include a link, button, or other user interface feature that can allow the consumer 126 to initiate claiming of the offer or promotion, for example by navigating the web module 130 to a promotion gateway 316, which can optionally make use of social network tags and redirects, etc. The promotion gateway 316 can be an implementation of a promotional management module 106 as discussed above. Website in-line promotions 306, social network action placements 310, and social network promotion modules 312 can include claiming functionality directly and can cause navigation of the web module 130 on the client device 132 directly to the promotion gateway 316. From the promotion gateway, an authentication process, for example as discussed above, can be initiated, for example by requesting permission to initiate authentication via an offer application 320 (which can for example be supported via or provided by the one or more promotional management modules 106). If the request to proceed with authentication is accepted, a promotional offer representation 204 can be displayed via the web module, for example as discussed above. If the request to proceed with authentication is not accepted, the consumer's web module 130 can be redirected to the offer micro-site 314 or to a social network promotion module 312 depending on how the promotion gateway was originally reached.

Consumer authentication can provide verification that a consumer has authenticated via an authentication server, which can optionally be a third-party authentication service, such as a social network (e.g., Facebook, Twitter, etc.). A non-authenticated consumer can optionally be required to login via the client vendor's branded authentication service (e.g., Facebook Open Graph application or the like). Once authenticated, a consumer is not required to authenticate again. In one example, this skipping of re-authentication for a previously authenticated user can be accomplished via a portal or other functionality provided by an authentication server 110 (for example by calling a Facebook software development kit or the like to confirm that a cached authentication remains valid.

All “friend” clicks can optionally be directed to the promotion gateway 316, which can performs redirects, tracking, meta-tagging, and the like. Redirecting can include redirecting a consumer clicking on a published offer or promotion based upon one or more criteria selected from a placement source (for example a consumer clicking an advertisement link on a social network site could be redirected to a landing page on the social network), a status of an offer or promotion (for example, if the offer or promotion has expired, the consumer can be redirected to a new promotion, to a standard page indicating that the promotion has expired, etc.), and a referrer (for example a person who created the published action, event, etc.). In some examples, all friend clicks can be tracked and friend actions can be associated to a referrer to help segment referrers (e.g., influencers). Tracking performed by the promotional gateway 316 can include all user requests (e.g., claim and view) pinging the promotional gateway 316, which can generate and retain information that can include without limitation a referring source (for example a referring website such as Facebook or Google or a placement such as an advertisement or a client website, or the like). The promotion gateway 316 can track unique parameters in URLs or the like. For example, the promotion gateway 316 can pass variables to associate traffic to referrers, pass locations of clicks (e.g. a feed, a ticker, a profile, etc.), and the like. Meta-tagging can include the promotion gateway 316 serving as a third-party proxy for tagging information of a site. This can allow for customer input of object descriptions, dynamically reading of existing meta-data and/or page DOM to formulate tags related to an open-standard, and the like.

Information about a consumer user can be obtained using one or more approaches. For example, one or more sources that can include but are not limited to cookies, reverse IP lookup (e.g. geo-targeting), profile data (e.g. from a social media service, from a customer loyalty program, or the like). In some implementations, a consumer user can be identified as belonging to a consumer segment, such as for example influencers, new visitors, existing advocates, or the like.

Some implementations of the current subject matter can include event tracking and/or event publishing features. For example, utilizing a social network's publishing system, actions related to offers or promotional events can be shared on social network. These shared actions or events can include notifications (e.g. by inclusion in a news feed or the like) that a specific consumer has claimed a specific offer or promotion (e.g. “John claimed a 20% off coupon at ABC Widget”). “Friends” or followers of the specific consumer that participated in the offer or promotion can then view the notifications of actions, events, relating to that specific consumer. Once a consumer has authenticated, all subsequent events can be automatically published on behalf of the consumer. A client vendor can also leverage the published notifications of events, actions, etc. to purchase advertisements referencing the notifications of events, actions, etc. For example, on Facebook, advertisers can purchase “sponsored stories” that are ads based upon structured actions (e.g., claimed) and objects (e.g., coupon). Tracking can also be performed for explicit actions, such as for example the incorporation of a button trigger or other user interface element that can be presented prior to purchase (for example a “want,” “own,” “pin,” “favorite,” etc. button or other element), following purchase (for example to “share” a purchase with a specific friend, “post” a purchase on the consumer's profile, and the like), group deals, sweepstakes, contests and refer-a-friend programs as well as for implicit actions that allow the consumer to frictionlessly share and broadcast purchases, redemptions of coupons, claims of coupons, and the like to other consumers or friends on a client site, social network, email list, or the like.

Event tracking can be in addition to the tracking performed by the promotion gateway 316 as discussed above. Promotion events, which can include placement clicks, claim requests, authentication events (e.g. successful authentications, denied authentications, etc.), offers delivered, offer actions (e.g., copy, shop, etc.), and the like can be tracked. Redemption and purchase events can also be tracked, for example by tracking conversion events related to an offer or promotion. In one example, a Javascript (or other scripting language) script, tracking pixel, or the like on a client vendor's confirmation page can notify the promotional service provider backend 102 when a consumer redeems a coupon relating to an offer or promotion.

A promotional management module 106 can also include a client vendor management module that can allow a user (e.g. a marketing manager) at or acting on behalf of the client vendor access to a set-up interface to create, manage and track promotions. Promotion set-up options available through the client vendor management module can include one or more of a promotion type, a promotion name, a promotion description, a promotion start date, a promotion expiration, one or more promotion terms, one or more promotion redirect requirements, and the like. Promotion segmenting options available through the client vendor management module can include defining promotions based upon types of users, and the like. Remarketing options available through the client vendor management module can include one or more of using a rule engine to target users based upon specified criteria, defining and/or selecting options relating to non-redemption of claimed offers or promotions (for example, by targeting consumers that have claimed an offer or promotion, but have not yet redeemed the offer or promotion, by offering second chance offers to consumers who have failed to redeem a claimed offer or promotion prior to the offer or promotion expiring), influencing claiming and/or redemption of offers or promotions (for example, by targeting consumers based upon their observed ability to influence friends or other associated consumers on previous promotions, by targeting consumers based on one or more predictive criteria relating to their potential ability to influence friends or other associated consumers, by providing a richer or exclusive offers to known or potentially influential advocates, etc.), e-mail notifications (for example by using triggered or time delayed email messages to drive desired actions), and the like. Extensible and interoperable framework options available through the client vendor management module can include the ability to access campaign management, monitoring, and analytic functionality through an application programming interface (API), and optimization and testing options available through the client vendor management module can include enabling the client vendor to test variations of marketing materials (for example by testing or reviewing copy, creative assets, layout and offer details, size of the offered discounts, expiration dates, etc.).

A promotional management module 106 can also include a reporting and analytics module that can include functionality relating to promotion performance reporting (for example for tracking, reporting, analyzing, etc. data relating to redemption rates for claimed offers or promotions, attributable order values for one or more offers or promotions, for conversion funnel analysis, etc.), segmenting (for example by consumer attributes such as grouping by likes, email addresses, gender, age, or the like), referrer or influencer reports (for example to track a number of application referrals attributable to a given influencing or referring consumer, average order values, redemption rates, etc.), placement traffic (for example impressions by consumers viewing the offer or promotion representation, number of clicks or other selection of the option to claim a presented offer or promotion, etc.), referring traffic (for example locations from which clicks originate, etc.).

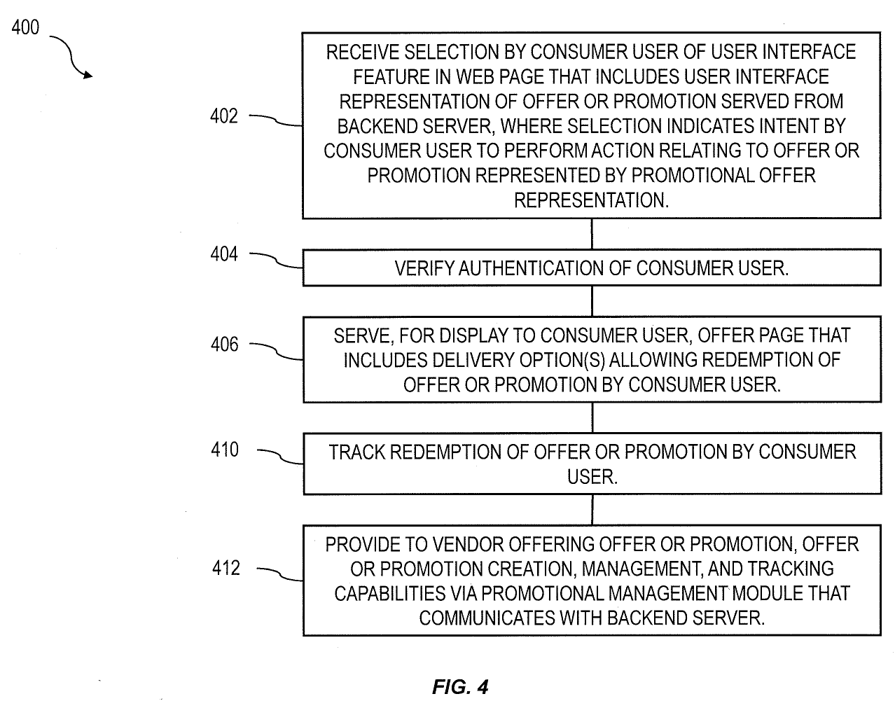

FIG. 4 shows a process flow chart 400 that illustrates features of a method consistent with implementations of the current subject matter. At 402, a backend server receives a selection by a consumer user of a user interface feature in a web page displayed by the consumer device. The receiving can occur from a consumer device, for example over a network. The web page includes a user interface representation of an offer or promotion served from the backend server. The selection indicates intent by the consumer user to perform an action relating to the offer or promotion represented by the promotional offer representation.

At 404, the backend server, optionally in communication with an authentication server, verifies authentication of the consumer user. The verifying authentication of the consumer user can optionally include determining whether the consumer user has already been authenticated either directly serving the offer page for display to the consumer user via the consumer device when the consumer user has already been authenticated at the time of the receiving of the selection; or communicating to the consumer device to request that the consumer user accept authentication of the consumer user's identity and allow access to the consumer user's profile data stored at an authentication data repository accessible by an authentication server when the consumer user has not already been authenticated at the time of the receiving of the selection. Upon receiving acceptance from the consumer user via the consumer device, the offer page can be server for display to the consumer user via the consumer device. The authentication server can optionally be a third party authentication server, such as for example a social networking server, etc. as noted elsewhere herein. The determining can optionally include performing a cache check, for example including accessing an authorization cache at the backend server to determine whether a stored authorization exists for the consumer user.

The backend server can optionally provide an authentication module to run within the web page displayed by the consumer device. The authentication module can communicate with the authentication server as part of the verifying authentication of the consumer user, and can perform operations such as returning crypto-signed authorization data when the consumer user has already been authenticated, executing an authorization process when the consumer user has not already been authenticated, etc.

At 406, the backend server serves an offer page to the consumer device for display to the consumer user. The offer page can include one or more delivery options allowing redemption of the offer or promotion by the consumer user. At 410, redemption of the offer or promotion by the consumer user can be tracked, and at 412 a vendor who offers the offer or promotion can perform creation, management, tracking, etc. via a promotional management module that communicates with the backend server. The one or more creation, management, and tracking capabilities can include at least one of defining the promotion or offer based upon consumer user types, using a rule engine to target consumer users based upon specified criteria, defining and/or selecting options relating to non-redemption of claimed offers or promotions, influencing claiming and/or redemption of offers or promotions.

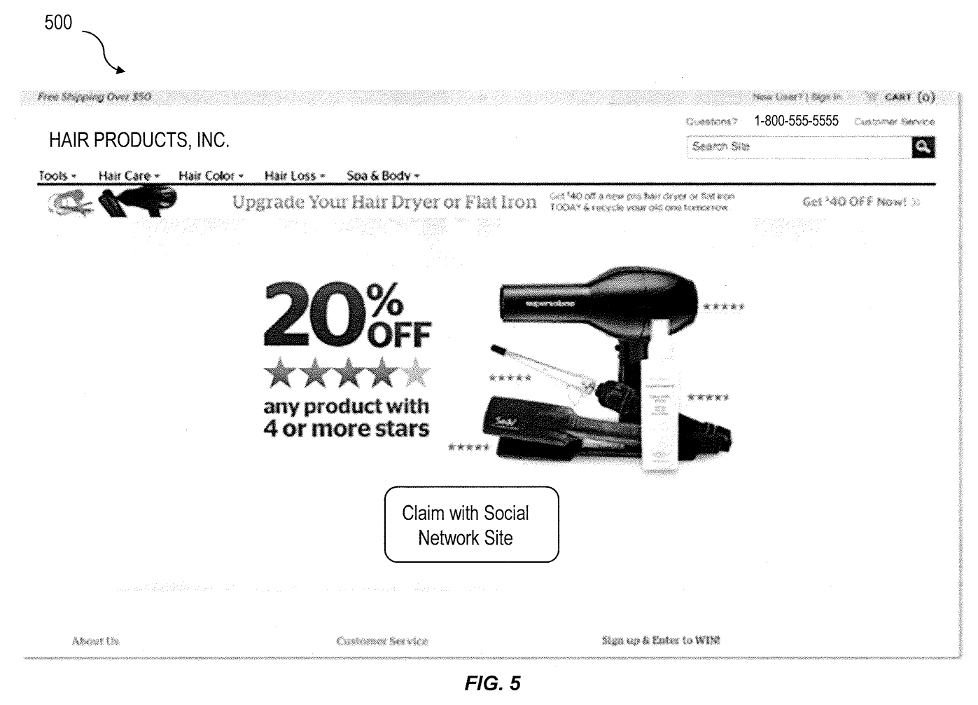

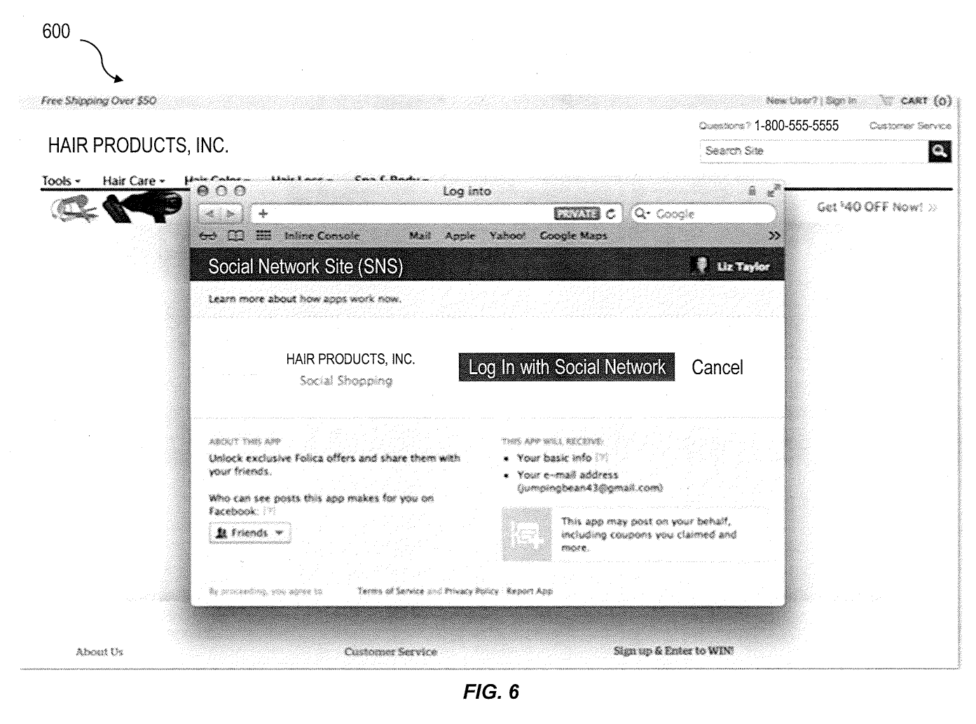

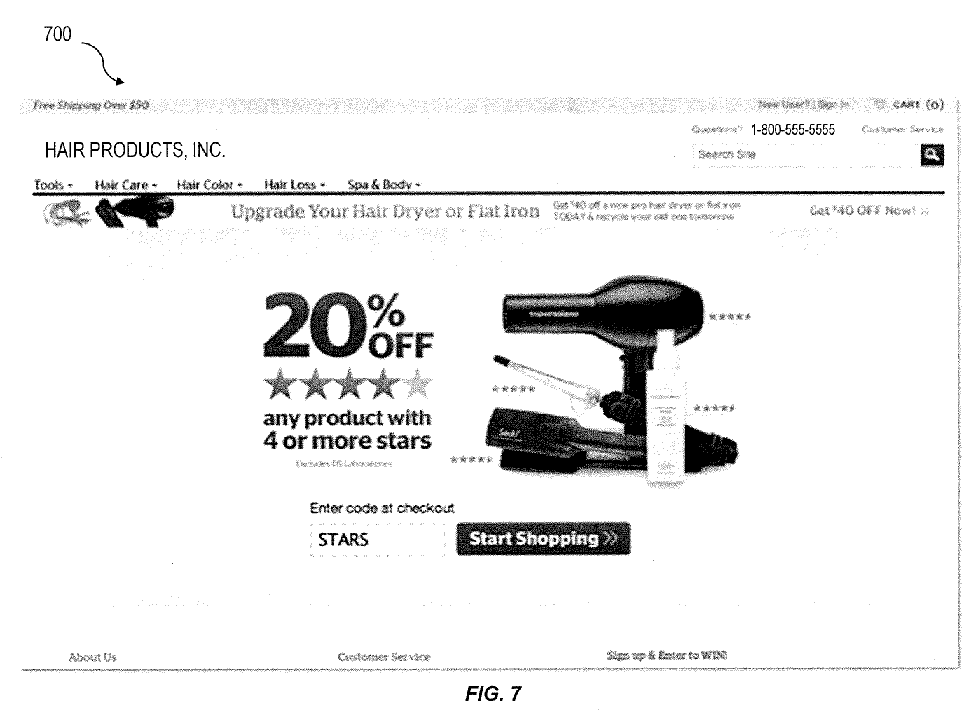

FIG. 5, FIG. 6, and FIG. 7 show screenshots 500, 600, and 700, respectively, illustrating features that can appear in one or more implementations of the current subject matter. For example, FIG. 5 shows a screen shot 500 of an example of a promotion management module displayed on a web page generated by a client vendor's e-commerce module. FIG. 6 shows a screen shot 600 of an example of an authentication module (e.g. provided through a social network site such as Facebook) displayed on a web page generated by a client vendor's e-commerce module. FIG. 7 shows a screen shot 600 of an example of delivery of a deferred redemption option such as a print and shop coupon provided by a promotion management module and displayed on a web page generated by a client vendor's e-commerce module.

Various implementations of the subject matter described herein may provide one or more of the following advantages relative to currently available approaches. For example, multi-channel distribution capabilities can enable placement promotional offer representation 204 (e.g. via a promotion management module 106) to be deployed to all client vendor properties (e.g., website, social network pages, etc.). The reach of a client vendor's brand can be extended, for example through the sharing of events, actions, etc. of a consumer participant in an offer or promotion via trusted communications links (e.g. social networks, private messaging such as e-mail or SMS/MMS, etc.). Gathering of consumer insights, including email can also be enables, for example through the permissioning of profile information, which can provide a client vendor additional insights on customers for future promotions and remarketing. Tracking of all (or at least one or perhaps many) consumer promotional actions can enable identification of key influencers and new categories of shoppers to target in future promotions. Offer distribution can be more tightly controlled, for example by requiring consumers to authenticate, which enables limiting of distribution of promotions and provides additional tracking to client vendors (e.g., claim to redemptions ratios). High value consumers can also be more readily acquired. By enabling consumers to easily participate in promotions and share with friends, a client vendor can more readily attract friends of consumers via promotions. Providing structured data into social networks can also enable a client vendor to easily track responses to sharing and to purchase advertisements related to the actions.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
receiving, at a backend server from a consumer device, a selection by a consumer user of a user interface feature in a web page displayed by the consumer device, the web page including a user interface representation of an offer or promotion served from the backend server, the selection indicating intent by the consumer user to perform an action relating to the offer or promotion represented by the promotional offer representation;
verifying authentication of the consumer user;
serving, from the backend server to the consumer device, an offer page for display to the consumer user, the offer page comprising one or more delivery options allowing redemption of the offer or promotion by the consumer user;
tracking redemption of the offer or promotion by the consumer user; and
providing, to a vendor who offers the offer or promotion, one or more offer or promotion creation, management, and tracking capabilities via a promotional management module that communicates with the backend server.

2. A computer program product as in claim 1, wherein the one or more creation, management, and tracking capabilities comprise at least one of defining the promotion or offer based upon consumer user types, using a rule engine to target consumer users based upon specified criteria, defining and/or selecting options relating to non-redemption of claimed offers or promotions, influencing claiming and/or redemption of offers or promotions.

3. A computer program product as in claim 1, wherein the operations further comprise providing a promotional management module that runs within the web page displayed by the consumer device, the promotional management module communicating with the backend server to send the selection for receiving by the backend server and to receive the server offer page.

4. A computer program product as in claim 1, wherein verifying authentication of the consumer user comprises:
determining whether the consumer user has already been authenticated; and
serving the offer page for display to the consumer user via the consumer device when the consumer user has already been authenticated at the time of the receiving of the selection; or
when the consumer user has not already been authenticated at the time of the receiving of the selection, communicating to the consumer device to request that the consumer user accept authentication of the consumer user's identity and allow access to the consumer user's profile data stored at an authentication data repository accessible by an authentication server, and upon receiving acceptance from the consumer user via the consumer device, serving the offer page for display to the consumer user via the consumer device.

5. A computer program product as in claim 4, wherein the authentication server comprises a third party authentication server.

6. A computer program product as in claim 4, wherein the determining comprises performing a cache check, the cache check comprising accessing an authorization cache at the backend server to determine whether a stored authorization exists for the consumer user.

7. A computer program product as in claim 4, wherein the operations further comprise providing an authentication module that runs within the web page displayed by the consumer device, the authentication module communicating with the authentication server as part of the verifying authentication of the consumer user, and performing operations comprising at least one of returning crypto-signed authorization data when the consumer user has already been authenticated, and executing an authorization process, when the consumer user has not already been authenticated.

8. A system comprising:
at least one programmable processor; and
a machine-readable medium storing instructions that, when executed by the at least one processor, cause the at least one programmable processor to perform operations comprising:
receiving, at a backend server from a consumer device, a selection by a consumer user of a user interface feature in a web page displayed by the consumer device, the web page including a user interface representation of an offer or promotion served from the backend server, the selection indicating intent by the consumer user to perform an action relating to the offer or promotion represented by the promotional offer representation;
verifying authentication of the consumer user;
serving, from the backend server to the consumer device, an offer page for display to the consumer user, the offer page comprising one or more delivery options allowing redemption of the offer or promotion by the consumer user;
tracking redemption of the offer or promotion by the consumer user; and
providing, to a vendor who offers the offer or promotion, one or more offer or promotion creation, management, and tracking capabilities via a promotional management module that communicates with the backend server.

9. A system as in claim 8, wherein the one or more creation, management, and tracking capabilities comprise at least one of defining the promotion or offer based upon consumer user types, using a rule engine to target consumer users based upon specified criteria, defining and/or selecting options relating to non-redemption of claimed offers or promotions, influencing claiming and/or redemption of offers or promotions.

10. A system as in claim 8, wherein the operations further comprise providing a promotional management module that runs within the web page displayed by the consumer device, the promotional management module communicating with the backend server to send the selection for receiving by the backend server and to receive the server offer page.

11. A system as in claim 8, wherein verifying authentication of the consumer user comprises:
determining whether the consumer user has already been authenticated; and
serving the offer page for display to the consumer user via the consumer device when the consumer user has already been authenticated at the time of the receiving of the selection; or
when the consumer user has not already been authenticated at the time of the receiving of the selection, communicating to the consumer device to request that the consumer user accept authentication of the consumer user's identity and allow access to the consumer user's profile data stored at an authentication data repository accessible by an authentication server, and upon receiving acceptance from the consumer user via the consumer device, serving the offer page for display to the consumer user via the consumer device.

12. A system as in claim 11, wherein the authentication server comprises a third party authentication server.

13. A system as in claim 11, wherein the determining comprises performing a cache check, the cache check comprising accessing an authorization cache at the backend server to determine whether a stored authorization exists for the consumer user.

14. A system as in claim 11, wherein the operations further comprise providing an authentication module that runs within the web page displayed by the consumer device, the authentication module communicating with the authentication server as part of the verifying authentication of the consumer user, and performing operations comprising at least one of returning crypto-signed authorization data when the consumer user has already been authenticated, and executing an authorization process, when the consumer user has not already been authenticated.

15. A computer-implemented method comprising:
receiving, at a backend server from a consumer device, a selection by a consumer user of a user interface feature in a web page displayed by the consumer device, the web page including a user interface representation of an offer or promotion served from the backend server, the selection indicating intent by the consumer user to perform an action relating to the offer or promotion represented by the promotional offer representation;
verifying authentication of the consumer user;
serving, from the backend server to the consumer device, an offer page for display to the consumer user, the offer page comprising one or more delivery options allowing redemption of the offer or promotion by the consumer user;
tracking redemption of the offer or promotion by the consumer user; and
providing, to a vendor who offers the offer or promotion, one or more offer or promotion creation, management, and tracking capabilities via a promotional management module that communicates with the backend server.

16. A computer-implemented method as in claim 15, wherein the one or more creation, management, and tracking capabilities comprise at least one of defining the promotion or offer based upon consumer user types, using a rule engine to target consumer users based upon specified criteria, defining and/or selecting options relating to non-redemption of claimed offers or promotions, influencing claiming and/or redemption of offers or promotions.

17. A computer-implemented method as in claim 15, wherein the operations further comprise providing a promotional management module that runs within the web page displayed by the consumer device, the promotional management module communicating with the backend server to send the selection for receiving by the backend server and to receive the server offer page.

18. A computer-implemented method as in claim 15, wherein verifying authentication of the consumer user comprises:
determining whether the consumer user has already been authenticated; and
serving the offer page for display to the consumer user via the consumer device when the consumer user has already been authenticated at the time of the receiving of the selection; or
when the consumer user has not already been authenticated at the time of the receiving of the selection, communicating to the consumer device to request that the consumer user accept authentication of the consumer user's identity and allow access to the consumer user's profile data stored at an authentication data repository accessible by an authentication server, and upon receiving acceptance from the consumer user via the consumer device, serving the offer page for display to the consumer user via the consumer device.

19. A computer-implemented method as in claim 18, wherein the determining comprises performing a cache check, the cache check comprising accessing an authorization cache at the backend server to determine whether a stored authorization exists for the consumer user.

20. A computer-implemented method as in claim 13, wherein at least one of the receiving, the verifying, the serving, the tracking, and the providing is performed by one or more systems comprising at least one programmable processor.
